(19) United States
(12) Patent Application Publication
(10) Pub. No.: US 2009/0307088 A1
(43) Pub. Date: Dec. 10, 2009

(54) Total Net Worth Derivation and Future Scenario Prediction

(75) Inventor: Gavin Littlejohn, Near Galasheils (GB)

Correspondence Address: Greenberg Traurig, 12th Floor, 1750 Tysons Boulevard, McLean, VA, 22102, US

(73) Assignee: Money Dashboard Ltd

(21) Appl. No.: 12/128,515

(22) Filed: May 28, 2008

(51) Int. Cl. G06Q 30/00; G06Q 40/00

(52) U.S. Cl. 705/14.53; 705/35; 705/14.66

(57) ABSTRACT

A system and method for managing a user's finances. Data over a network relating to a user's personal financial position are received over a network from at least one system, including an end user system. The data relating to the user's personal financial position are stored on a computer readable medium and aggregated. Anticipated changes in the user's personal financial position are forecast using the aggregated data using stochastic forecasting techniques. The aggregated data relating to the user's personal financial position in the form of total net worth and the forecasts of the anticipated changes in the user's personal financial position are displayed on a display device connected to the end user system

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for allowing a user to manage their financial position, and more particularly to web based systems and methods that allow an end user to view their total net worth online, select financial options, and project the performance of their finances using stochastic forecasting techniques.

### BACKGROUND OF THE INVENTION

Many consumers lack confidence in their financial decision-making. The reasons are many and varied. Consumers are moving homes, jobs and relationships more frequently. Financial choices have increased and made decisions more complicated. Consumers are put off from decisions by the financial language used to describe financial choices and lack basic financial education and financial literacy. Consumers are naturally suspicious of limited choices, and expect rapid access to information.

Consumers are not purchasing the financial products they need—evidenced by the rapid rise of consumer debt and the comparative lack of pension and retirement savings. The typical consumer is often unaware of his or her total net worth, often does not have long-term financial goals, and is not capable of selecting or purchasing financial products that will increase the consumer's net worth with an acceptable level of risk. Financial advisors are available, but are only used by narrow demographic groups, e.g. aged 40+ and semi-affluent.

### SUMMARY OF THE INVENTION

In one embodiment, the invention provides a method and a computer-readable medium having computer-executable instructions for a method for managing a user's finances. Data over a network relating to a user's personal financial position are received over a network from at least one system, including an end user system. The data relating to the user's personal financial position are stored on a computer readable medium and aggregated. Anticipated changes in the user's personal financial position are forecast using the aggregated data using stochastic forecasting techniques. The aggregated data relating to the user's personal financial position in the form of total net worth and the forecasts of the anticipated changes in the user's personal financial position are displayed on a display device connected to the end user system

In another embodiment, the invention provides a system comprising: a data receiving module that receives data relating to a user's personal financial position from at least one system, including an end user system; a data storing module that stores the data on a computer readable medium; a data aggregating module that aggregates the data; a forecasting module that forecasts anticipated changes in the user's personal financial position using the aggregated data using stochastic forecasting techniques; and a data display module that displays the aggregated data relating to the user's personal financial position in the form of total net worth and the forecasts of the anticipated changes in the user's personal financial position on a display device connected to the end user system.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a flowchart illustrating one embodiment of a high-level process 100 for an end user to manage his or her finances using at least one embodiment of the disclosed system and method.

FIG. 2 is a high-level module diagram illustrating one embodiment of the components of the disclosed system and method.

FIG. 3 is a diagram of a physical system capable of supporting at least one embodiment of the disclosed system and method.

FIG. 4 illustrates one embodiment of modules comprising a server capable of supporting at least one embodiment of the processes and components illustrated in FIG. 1-2.

FIG. 5 illustrates one embodiment of a graphical user interface for initial user profile creation.

FIG. 6 illustrates one embodiment of a personal preferences entry page.

FIG. 7 illustrates one embodiment of an account details entry page.

FIG. 8 illustrates one embodiment of an income details entry page.

FIG. 9 illustrates one embodiment of an investments entry page.

FIG. 10 illustrates one embodiment of a graphical user interface that displays the user's debt using a dashboard-style presentation.

FIG. 11 illustrates how the display illustrated in FIG. 10 changes when mortgages are selected.

FIG. 12 illustrates how the display illustrated in FIG. 10 changes when credit cards are selected.

FIG. 13 illustrates one embodiment of a modeling function displayed when a “Model” button is selected.

FIG. 14 illustrates one embodiment of a graphical user interface that displays the value user's real property using a dashboard-style presentation.

FIG. 15 illustrates one embodiment of a modeling function displayed when the “Model” button is selected.

FIG. 16 illustrates one embodiment of a graphical user interface that displays the value of a user's assets using a dashboard-style presentation

FIG. 17 illustrates one embodiment of a graphical user interface that displays the liquidity of a user's assets using a dashboard-style presentation

FIG. 18 illustrates one embodiment of a graphical user interface that displays the allocation of a user's assets using pie charts.

FIG. 19 illustrates one embodiment of a graphical user interface that allows a user to evaluate and plan the user's long-term investment strategy using a dashboard-style presentation.

FIG. 20 illustrates one embodiment of a modeling function displayed when the “Model” button is selected.

FIG. 21 illustrates one embodiment of a graphical user interface that allows a user to evaluate and plan pension and retirement investments using a dashboard-style presentation.

FIG. 22 illustrates one embodiment of how the graphical user interface in FIG. 21 changes when parameters are changed.

FIG. 23 illustrates one embodiment of a graphical user interface that allows a user to display and model spending patterns throughout a month.

FIG. 24 illustrates one embodiment of a graphical user interface that allows a user to see the forecasted effects of the user's current financial plans over time.

FIG. 25 illustrates one embodiment of a graphical user interface that allows a user to model competing choices for the distribution of financial services.

FIG. 26 illustrates one embodiment of a graphical user interface that allows a user to see the forecasted effects of his chosen new plan over time at a point in the future compared to his original plan.

### DETAILED DESCRIPTION

The present invention is described below with reference to block diagrams and operational illustrations of methods and devices to store and/or access streaming media. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers.

For the purposes of this disclosure a system component is a related group one to many modules and data stores that provide functions directed to a conceptual subject area supported by a system. A module or data store may provide functions to more that one component of a system. A component may comprise one or more subcomponents.

Reference will now be made in detail to illustrative embodiments of the present invention, examples of which are shown in the accompanying drawings.

The embodiments discussed below generally relate to methods and systems for providing a set of online, graphic, web enabled tools that allow an end user to evaluate their current financial condition, set financial goals and plan for the future, and evaluate progress towards achieving such goals.

In one embodiment, the system is a combination of building blocks that allow a user to access and understand a wide variety of competing financial choices based on their own self profiling, behavioral and contextual elements and using both aggregation of their current and historical balance sheet and stochastic forecasting models, to arrive at a perspective view of their competing financial decisions on their total net worth over time. The crystallization of the cause and effect of competing choices and likely future impact of financial decisions increases the user's financial confidence and allows them to link to products in the financial market that will assist them in achieving their chosen objectives by disqualifying unsuitable financial vehicles. Once user decisions are implemented, the system monitors those choices over time and alerts the user if significant divergence to the forecast occur.

In one embodiment, the system provides for: automated aggregation of all of a user's personal financial data, giving the total net worth of the individual user using, for example, a private balance sheet of all assets and debts; collection of user profile information, and behavioral and contextual decisions made by the user; intelligent wizards and interface elements which utilize a self profiling process, based on the personal decisions and data aggregations to disqualify potential financial choices and to serve relevant product marketing information to the user; stochastic forecasting of self profiled financial choices; distribution of all types of financial products via the Internet (e.g. selling products online), and management of the user's total net worth through time, using thresholds, and alerts.

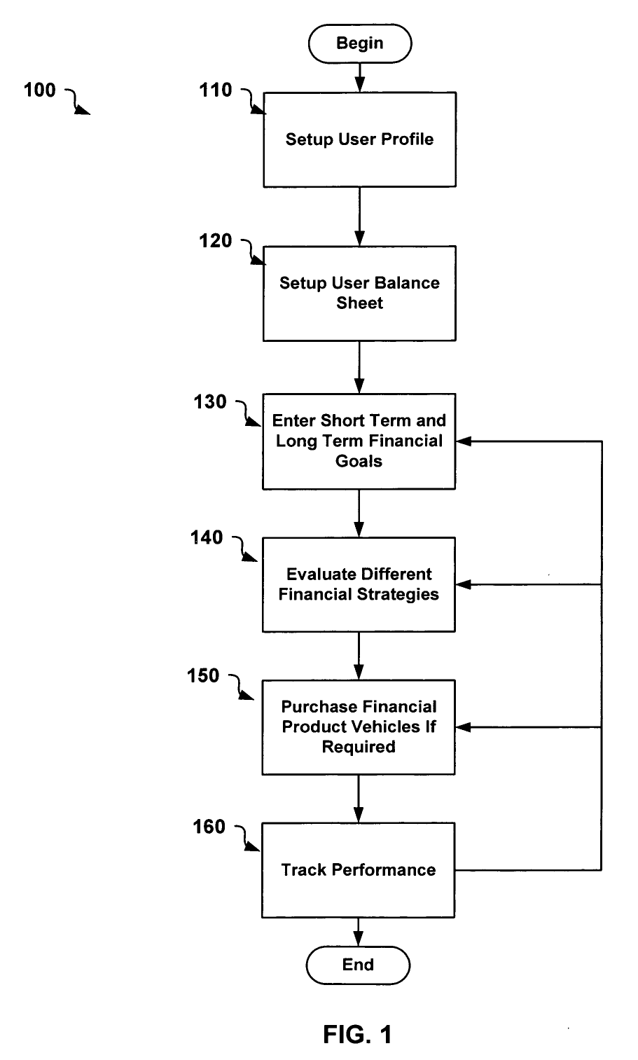

FIG. 1 is a flowchart illustrating one embodiment of a high-level process 100 for an end user to manage his or her finances using at least one embodiment of the disclosed system and method. An end user first sets up a user profile 110. The user next enters financial data to set up a simple balance sheet 120 of his or her position focused on total net worth. The end user is then able to set long term and short term financial goals 130 and evaluate different financial strategies for achieving such goals 140. The end user may then purchase various financial product vehicles 150, if required, and track the performance of his or her investments on an ongoing basis 160. The user may iteratively repeat any of the steps 130 to 160 to actively manage his or her total net worth.

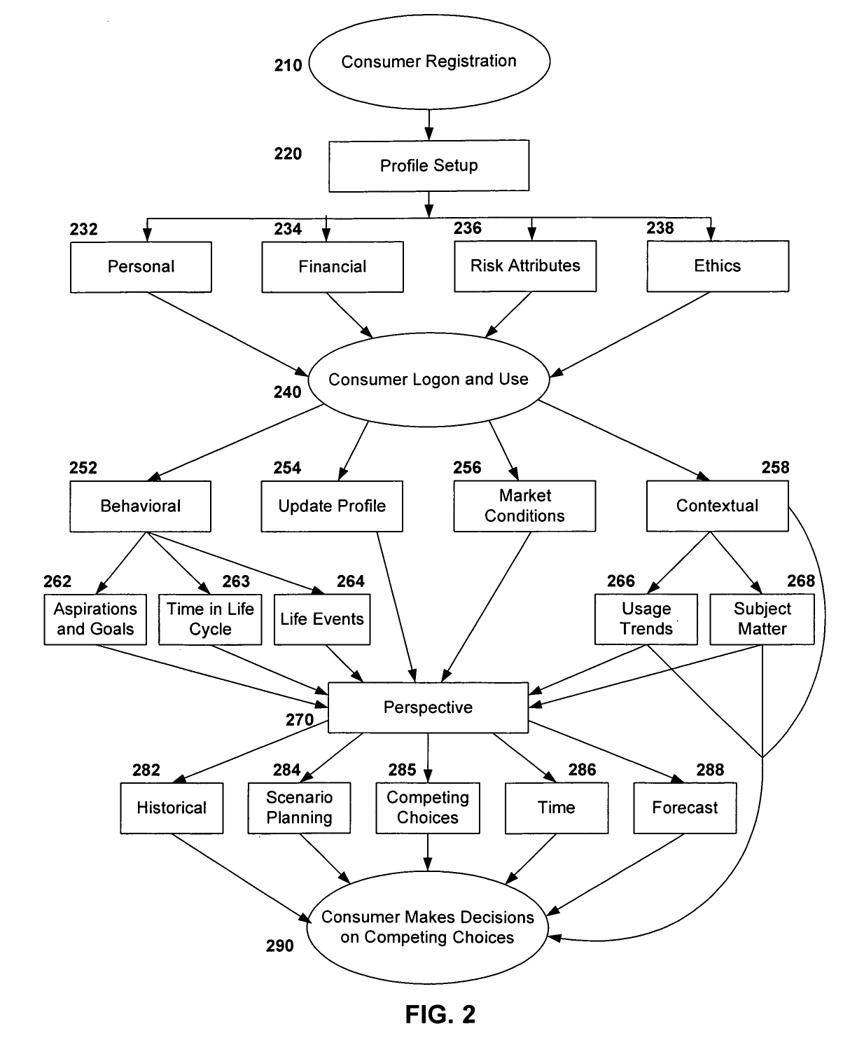

FIG. 2 is a high-level module diagram illustrating one embodiment of the disclosed system and method. In one embodiment, upon registering with the system 210, a user profile setup 220 component collects profile data of an individual, the data comprising: personal information 232, such as name, address, postal code, date of birth, marital status, children, and job status and type; financial information 234 including, income and expenses, and assets and liabilities, and existing financial relationships; psychometrics such as attitudes toward risk 236, desire to achieve goals, and so forth; and personal ethics and beliefs 238 relating to, for example, environmental, religious, and cultural issues.

In one embodiment, the system, when a registered user logs onto the system 240, a behavior tracking component 252 tracks user behavior, where behavior may be broadly defined as including where the user has been, what the user is currently doing and where the user wants to go as an individual. Thus, user behavior may include: aspirations and goals 262 such as life targets, future planned decisions, events, and so forth; the time in user's life cycle 263, e.g. post-higher education, pre-retirement, retirement; life events 264 including marriage and divorce, changing or losing a jobs, a significant bonus or inheritance, birth, bereavement, moving house, illness, and so forth. An update profile component 254 may then update the user's profile based on the user's behavior.

In one embodiment, the system has a market conditions component 256 that tracks market conditions in regional, national and global markets, and presents the information to enlighten and encourage financial choices that best meet the users goals in light of their attitudes, inducing an optimistic, pessimistic or realistic reaction. Market information may include: financial markets such as equities, bonds, precious metals, or commodities, market trends; market volatility, and takeovers; government policy such as tax and budgets, fiscal and monetary policy, central bank rates and inflation; and the reaction of other users of the system.

In one embodiment, a contextual component system 258 modifies the system's interfaces and behavior based on context. For example, the system may support pension content using pension interface pages, mortgage and property content using property pages, and interface pages. The system may additionally track usage trends such as patterns of application usage, top pages, access times, access window, frequency of page visits, and so forth. The system may further provide targeted marketing of financial products (e.g. banners, or flash media) that is relevant to the user's current context. For example, the system may provide for advertisements relating to retirement investments on a pension interface page. Advertisements for such investments based on user profile and behavioral data, as well as market conditions. For example, a risk-adverse investor would not receive advertisements for high-risk investments.

In one embodiment, the system provides a perspective component 270 that presents and analyzes profile, contextual, behavioral, and market information using a framework that enables the user to evaluate the competing choices for financial decision through time. The system may store historical data 282 and planned scenarios 284, forecast investment outcomes 288 using stochastic modeling and future analysis, and determine the impact of changes in circumstances including the impact of major life events. Competing financial choices 285 may be presented serially or side by side. The system may further provide interface elements to enable a user to look back at actual historical data over time 286, to compare actual performance against earlier decisions, and to inform choices in current competing decisions for the future forecast. In one embodiment, the system allows the user to view his total net worth over time.

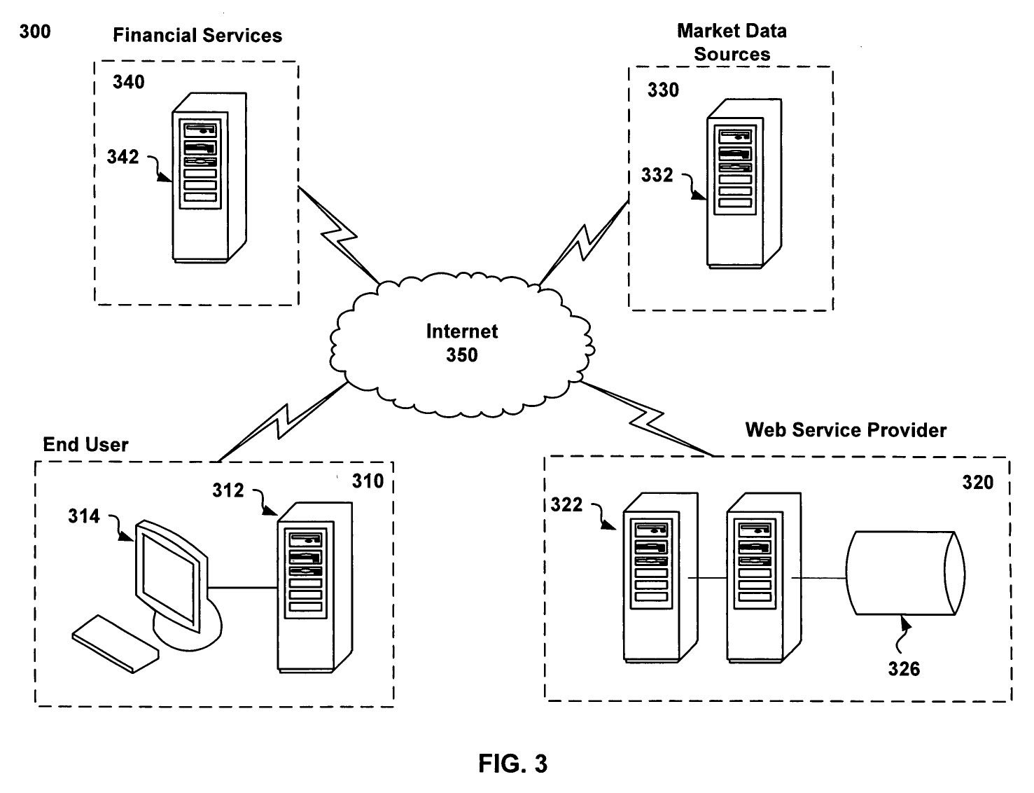

FIG. 3 is a diagram of a physical system capable of supporting one embodiment of the disclosed system and method. In one embodiment, the components of the system as disclosed in FIG. 2 are hosted on a server 322 of a web services provider 320. The components may be implemented as modules located and executed on the server 322 or may be downloaded to end user systems 312. User profiles and other system data are securely stored on permanent or temporary storage 326 located at the service provider's 320 site. Users 310 of the system access the system via an external network, for example the Internet 350, using end user systems 312 having graphic user interface capabilities 314.

The service provider 320 may additionally obtain financial and market data from financial services 340 having systems 342 accessible to the service provider 320 over the Internet 350. The service provider 320 may additionally obtain market data from other market data sources 330 having systems 332 accessible to the service provider 320 over the Internet 350. The system may additionally interface to, or redirect users 310, to financial services 340 having systems 342 accessible to the service provider 320 or the user 310 over the Internet for the purpose of allowing the user 310 to purchase and otherwise manage financial vehicles online.

In one embodiment, the system enables the service provider to collect revenues by charging pay-per-lead and premium commissions on financial product vehicles purchased by users by processes mediated through the system, as well as through advertising embedded in the system's interface. The system may provide for marketing of products to a captive market during the user's decision-making process. The system may thereby create super efficiencies in product manufacturing and in channel marketing by accurately targeting potential buyers with relevant products based on profile, behavioral, contextual, and market condition elements.

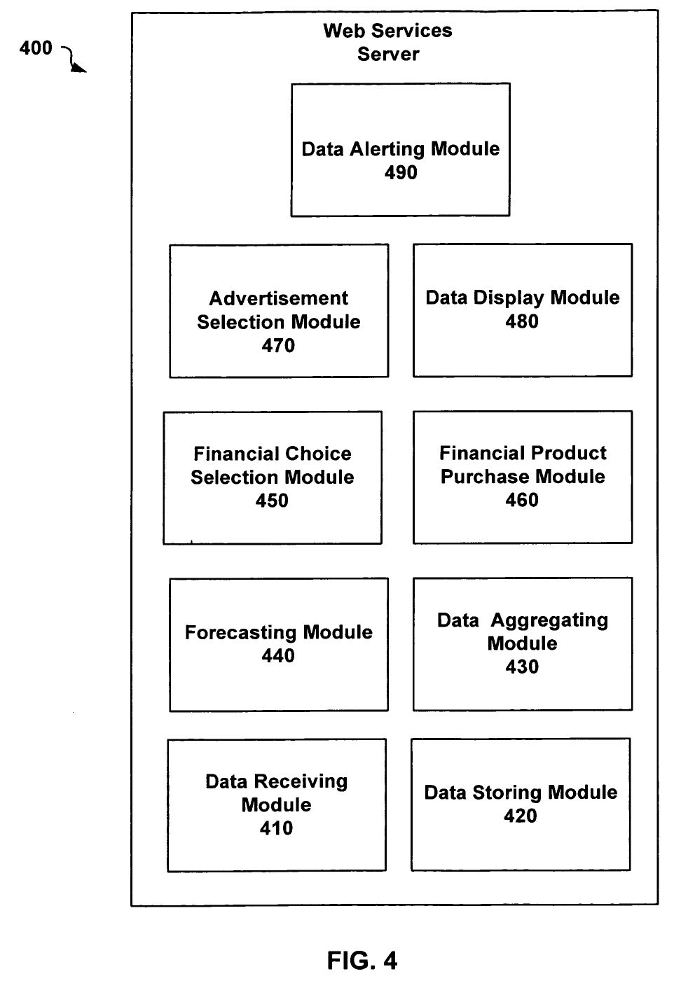

FIG. 4 illustrates one embodiment of modules comprising a server 400 capable of supporting at least one embodiment of the processes illustrated in FIG. 1-2. The server comprises a data receiving module 410 configured for receiving data over a network from one or more systems (including end user systems) relating to user personal financial positions. The data receiving module 410 may be further configured to receive data relating to user financial goals, user selections of financial options, and additional data relating to users, including user profile data, user behavioral data, contextual data and market condition data. User profile data may include risk aversion, ethical preferences, ability to afford and sustain financial products, cash flow analysis, tax efficiency, and liquidity requirements. In one embodiment, at least a portion of the data received by the data receiving module 410 is received from external systems, for example, from financial services providers, that are capable of supplying financial data for users.

The server further comprises a data storing module 420 configured for storing data relating to user financial positions on a computer readable medium. The data storing module 420 may be additionally configured to accumulate data relating to user financial positions over a period of time. The server further comprises a data aggregating module 430 configured for aggregating the data relating to the user's financial positions, and a forecasting module 440 configured for forecasting anticipated changes in user financial positions using the aggregated data relating to the user financial positions using stochastic forecasting techniques.

The server may further include a financial choice selection module 450 configured to select financial options that will help to achieve user financial goals. The financial choice selection module 450 may be additionally configured to use profile data, behavioral data, contextual data and market condition data to select financial options. The server may further include a financial product purchase module 460 that sends transactions to financial product providers over a second network to purchase selected financial options on behalf of users.

The server may further include a advertisement selection module 480 configured for selecting targeted advertisements using data which may include user profile data, user behavioral data, user context data and data relating to market conditions. Selected advertisements may relate to, for example, financial products which may be of interest to a specific user in light of the user's current context, the user's profile and past behavior, and market conditions.

The server additionally comprises a data display module 480 configured for displaying aggregated data relating to user personal financial positions in the form of user total net worth and forecasts of anticipated changes in user personal financial positions on a display device connected to end user systems. The data display module 480 may be additionally configured for displaying the performance of the users financial choices over the period of time. In one embodiment, aggregated data relating to user personal financial positions, including total net worth and forecasts of anticipated changes in the user personal financial positions, are displayed using a graphical interface in the form of a dashboard (as discussed in greater detail below.)

The data display module 480 may be additionally configured for displaying financial options selected by the financial choice selection module 450. In one embodiment, financial options may be displayed including a comparison of projected future financial scenarios to help identify the most effective future total net worth scenario for a specific user over a period of time. The data display module 480 may be additionally configured for displaying advertisements selected by the advertisement selection module 480 using any technique known in the art (e.g. banner ads, Flash videos, popup ads, etc.)

The server may further comprise a data alerting module 490 that tracks user plans over time and alerts the user to any significant divergence between the current actual results and the previous forecast, helping the user to manage financial risk. Alerts may be provided using any technology capable of delivering message text to a user, including, without limitation, emails, instant messages, text messages delivered to mobile devices, as well as displaying text messages on one or more interface pages.

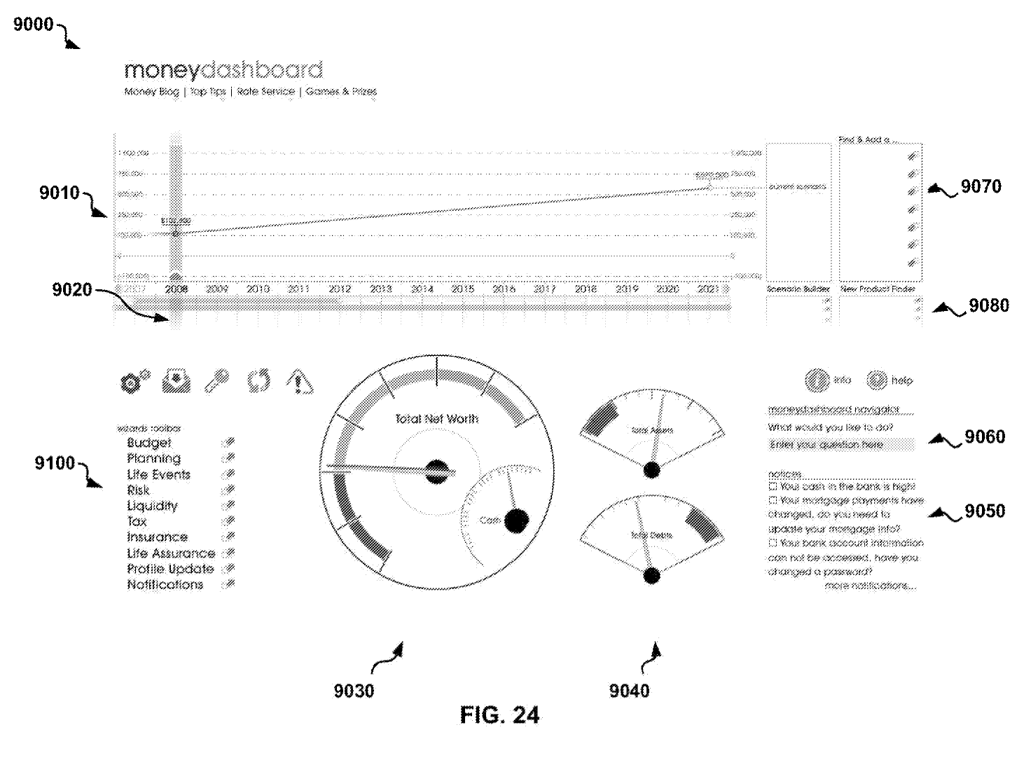

In one embodiment, the interface to the system is implemented as an intuitive, graphical dashboard. The role of the dashboard is to create an environment where users can be confident in the relationship between their financial choices and the financial impact of those choices. The user is able to log-in to the system to track and manage their finances. When logged in, the user enters a navigation dashboard, which is, in one embodiment, in an accessible dashboard format of financial information (see, e.g., FIG. 24.) The system always defaults to the highest level of dashboard summary to make the complex information as simple as possible, although each dial has a button that allows the user, should they wish, to navigate their way through their dashboard showing ever greater details of the underlying causes of each position.

Each scenario investigated by the user will introduce product provider's products that best match the user's needs. Alternate scenarios may be saved for comparison. Each comparison will focus on total net worth as the focal point, so debts are viewed as investment opportunities. For example, a user could use income to pay down a credit card balance at a high interest rate before saving cash at a lower rate. Each choice, after being rated on total net worth, may additionally be rated for tax efficiency, financial risk and liquidity.

The user's earning and spending patterns and subsequent choices are represented using budgeting dials. If the user starts to drift from planned objectives, through undisciplined behavior patterns or due to changes in the market conditions, the system may additionally notify users via text message or email to revisit the dashboard to understand the changes and actions they could take to remedy any disadvantage or imbalance in their financial position.

The user is additionally able to use the interface to see the impact of the various choices over time. At the core of the user's experience is the relationship between their income, from whatever source, and the distribution of that income, normally based on a monthly cycle. The user will learn that any choice of how to distribute the income will affect capability in other areas. Choices are subdivided for the user into categories including: obligations such as tax, rent, bills, mortgage or loan payments; aspirations such as savings, pensions, investments, protection, and available funds for daily living.

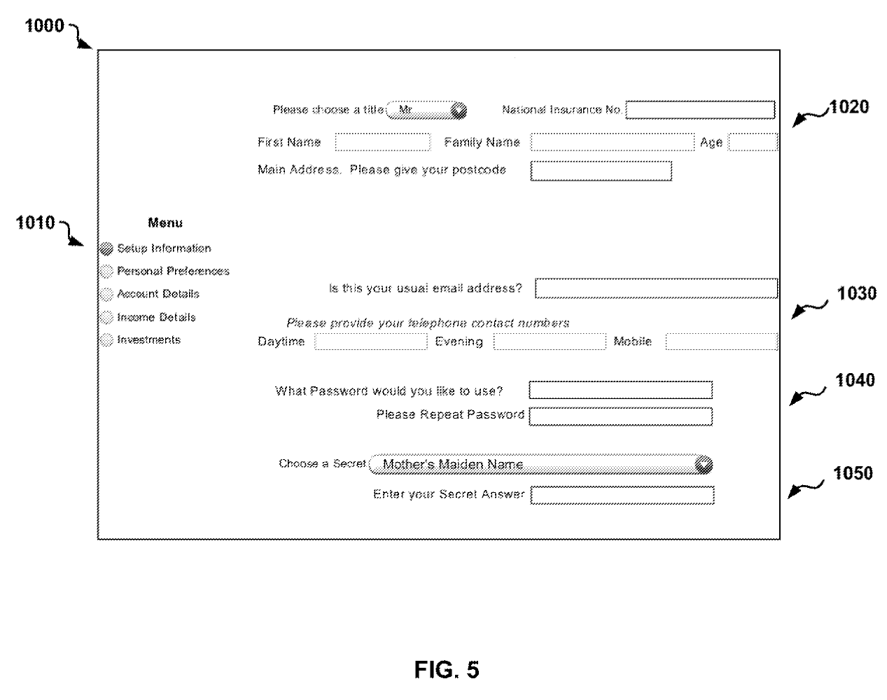

FIG. 5 to FIG. 9 illustrates one embodiment of a graphical user interface for initial user profile creation. FIG. 5 illustrates an initial setup page 1000, which may be selected using a radio button 1010. The user enters name and address information 1020, additional contact information 1030, a password 1040, and one of more security verification questions 1050. After completing the basic setup information, the user may use the radio button 1010 to select a personal preferences page, an account details page, an income details page, or an investments page.

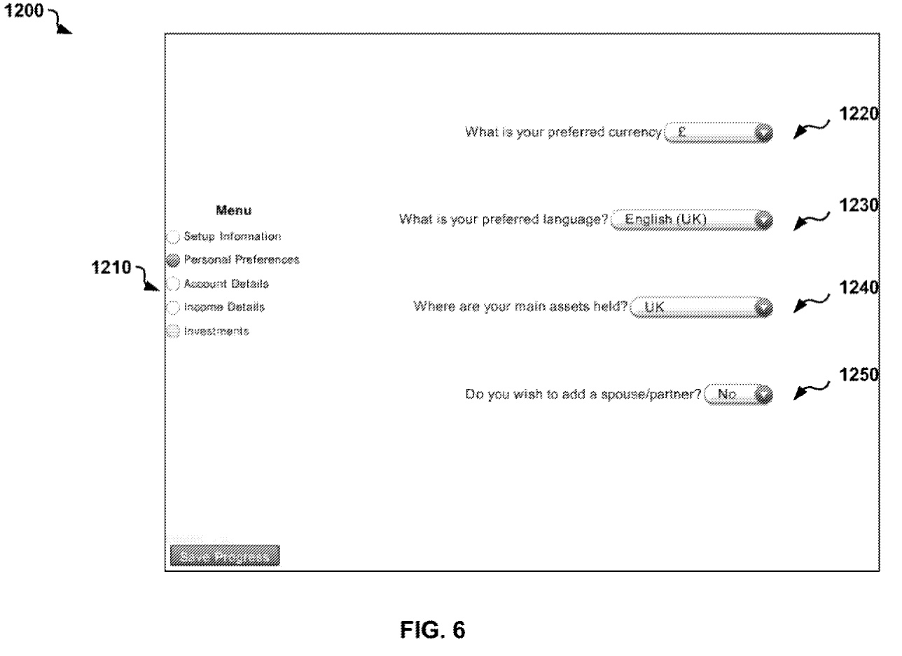

FIG. 6 illustrates one embodiment of a personal preferences entry page 1200, including a set of radio buttons 1210 for selecting other setup pages. The page includes user preferences such as, for example, preferred currency 1220, preferred language 1230, and a place where the majority of the user's assets are held 1240. The page may additionally include the ability to consolidate the user's profile with that of a second user, such as a spouse or partner 1250. The page may also include the user's overall risk aversion and ethics (not shown), such as a user's preference for green companies.

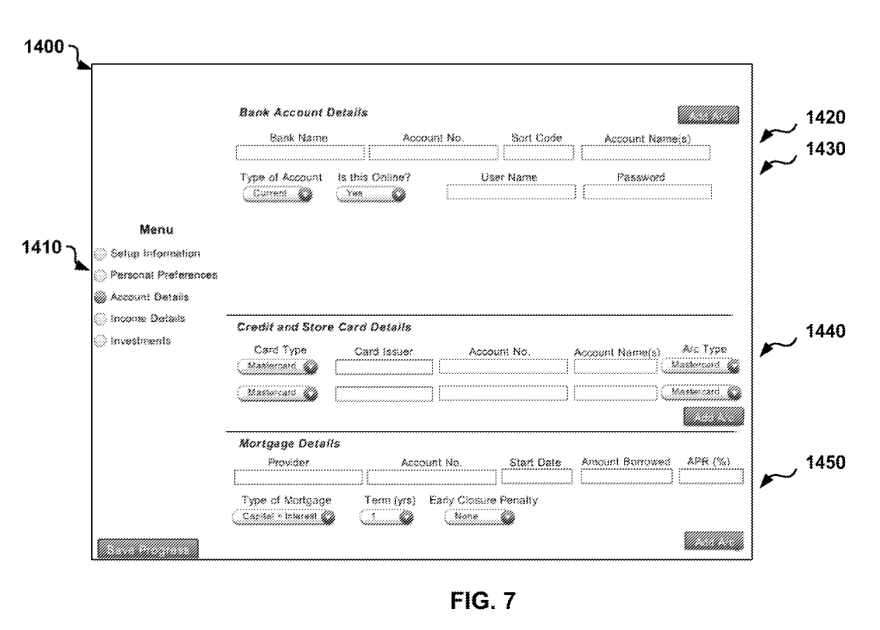

FIG. 7 illustrates one embodiment of an account details entry page 1400 including a set of radio buttons 1410 for selecting other setup pages. The page provides the capability to enter asset type accounts such as bank accounts 1420, and may include information for online banking. The page additionally provides for entry of liability accounts such as credit cards 1440 and mortgages 1450.

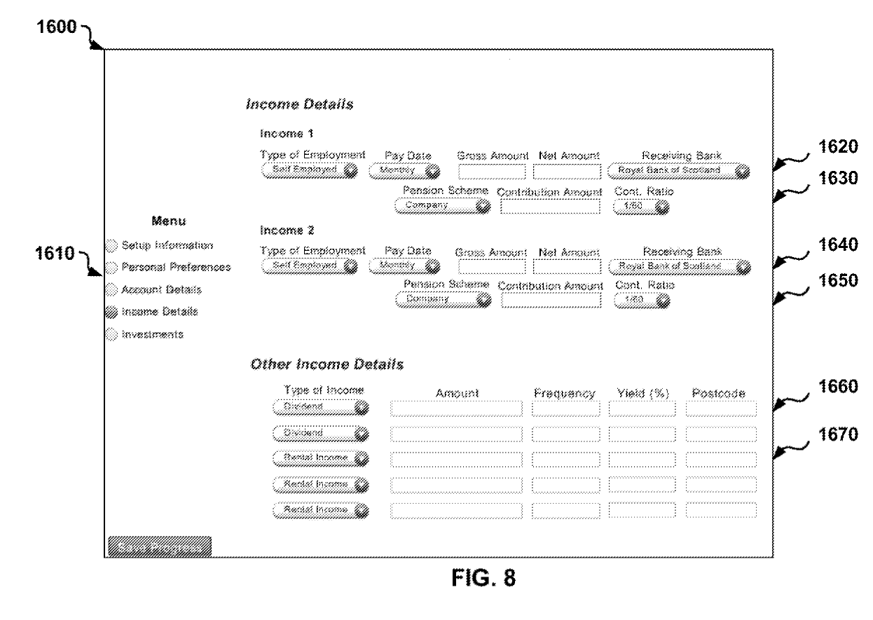

FIG. 8 illustrates one embodiment of an income details entry page 1600 including a set of radio buttons 1610 for selecting other setup pages. The page provides the capability to enter gross and net Income from one or more employment positions 1620 and 1640. Such information may include pension contributions 1630 and 1650. The page additionally provides for entry of any other type of non-employment income such as stock dividends 1660 and rental income 1670.

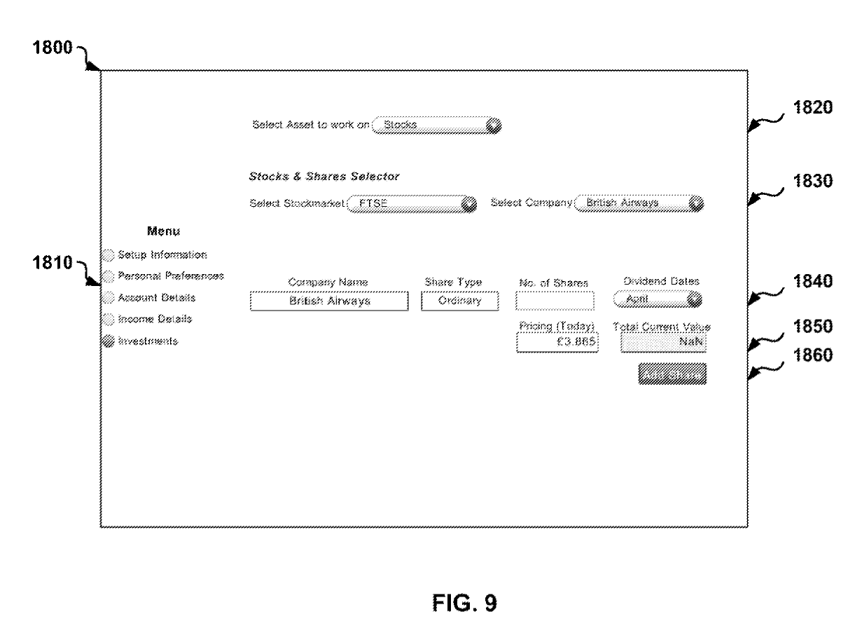

FIG. 9 illustrates one embodiment of an investments entry page 1800 including a set of radio buttons 1810 for selecting other setup pages. The page provides the capability to select types of investments using a pull-down menu 1820. The illustrated example displays an entry page for a stock. The page includes pull down menus for selecting a specific stock within a specific exchange 1830. The page provides an entry line to enter the number of shares of the selected stock 1840. The page displays the current share price of the stock and the total value of the stock 1850. The entry may be added to the user's profile by clicking on an “Add Share” button 1860.

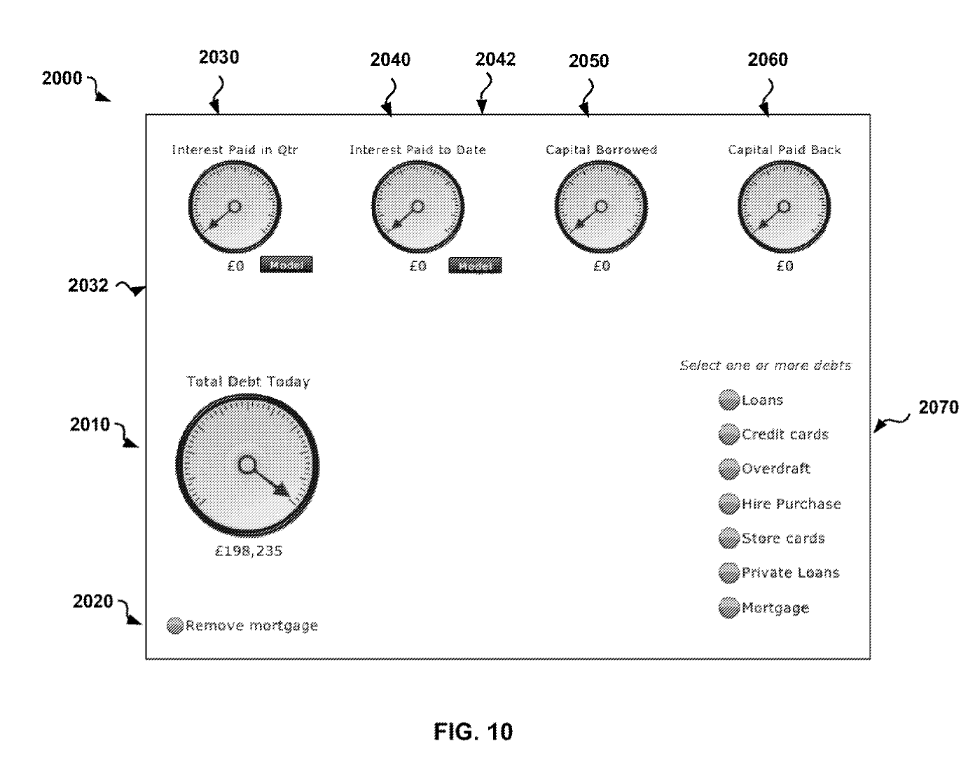

FIG. 10 to FIG. 13 illustrates one embodiment of a graphical user interface 2000 that displays the user's debt using a dashboard-style presentation. The interface includes a large dial showing the users debt 2010, and smaller dials showing total interest paid on debt within the last quarter 2030 and to-date 2040, capital borrowed 2050 and capital paid back 2060. The interface further provides a button 2020 to exclude mortgage debt from the displayed debt. The interface further provides an array of selector buttons 2070 which allows the selection of specific types of debt, such as loans

FIG. 10 displays one embodiment of the initial presentation of the interface 2000 where no specific types of debts have been selected. The users debt displayed 2010 is the user's total debt, including all liabilities and mortgages, and the smaller dials 2030 to 260 do not reflect interest payments or changes in capital. If the “remove mortgage” button 2020 is selected, the total on the large dial 2010 does not include mortgage debt.

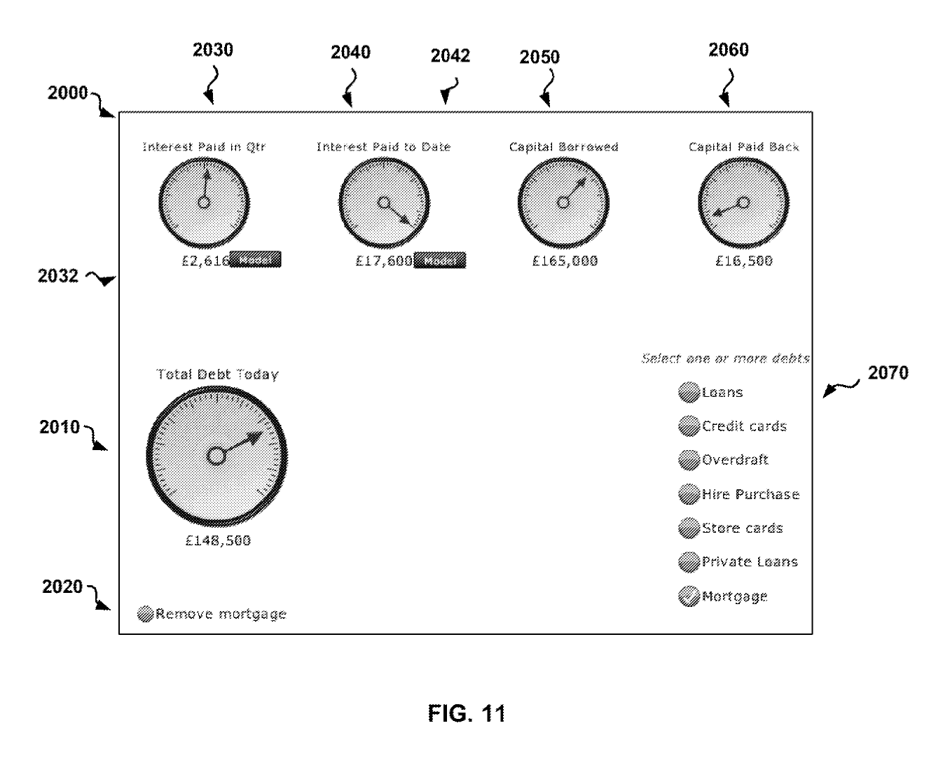

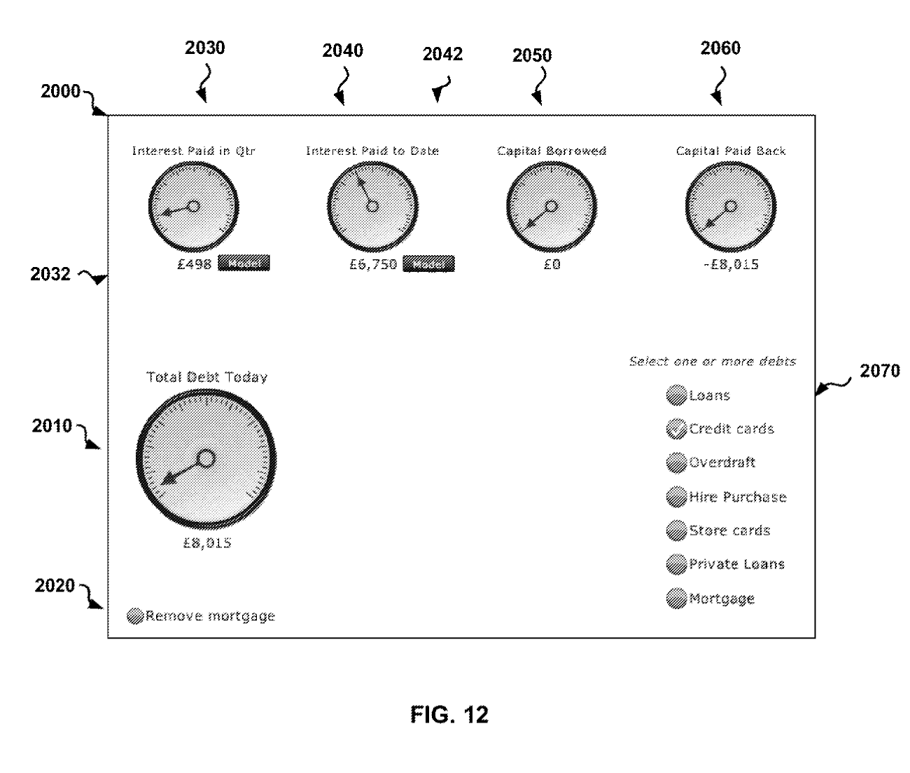

FIG. 11 illustrates how the display changes when mortgages are selected. The total dial 2010 reflects mortgage debt only. The interest dials 2030 and 2040 reflect interest paid during the current quarter and the life of the loans respectively. The capital borrowed dial 2050 reflects the total originally borrowed, and the capital paid dial 2060 reflects the capital (equity) paid back. FIG. 12 illustrates how the display changes when credit card are selected. The total dial 2010 reflects credit card debt only. The interest dials 2030 and 2040 reflect interest paid during the current quarter and the life of the credit card debts respectively. The capital borrowed dial 2050 is zero and the capital paid dial 2060 is negative.

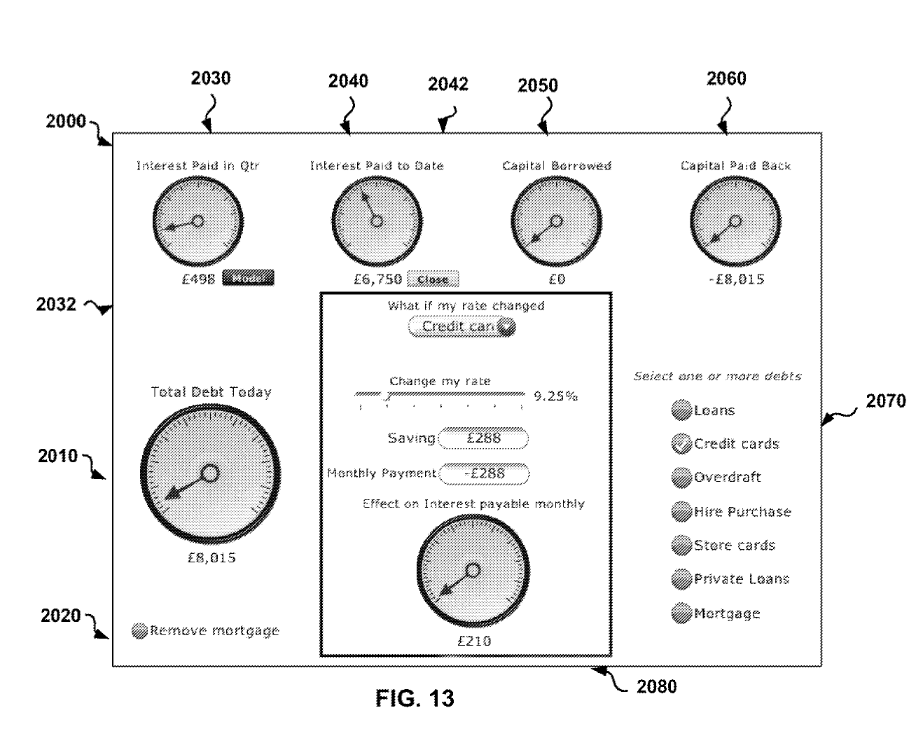

The interface shown in FIG. 10 to 13 includes a modeling function for modeling the effect of changes in interest payments. The function is activated by selecting a “Model” button 2032 or 2042. FIG. 13 illustrates one embodiment of a modeling function displayed when the “Model” button 2032 is selected. The interface displays a pop-up window which provides a pull-down menu to allow the user to select a type of debt and a slider bar to vary the interest rate on the debt. The pop-up window 2080 displays the total savings and the change in monthly payments due to changes in interest rates.

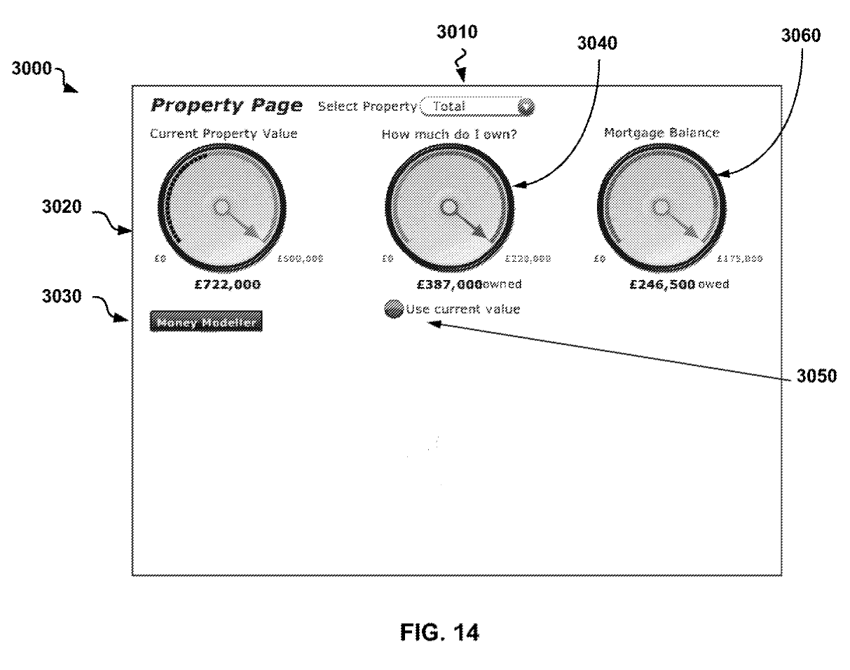

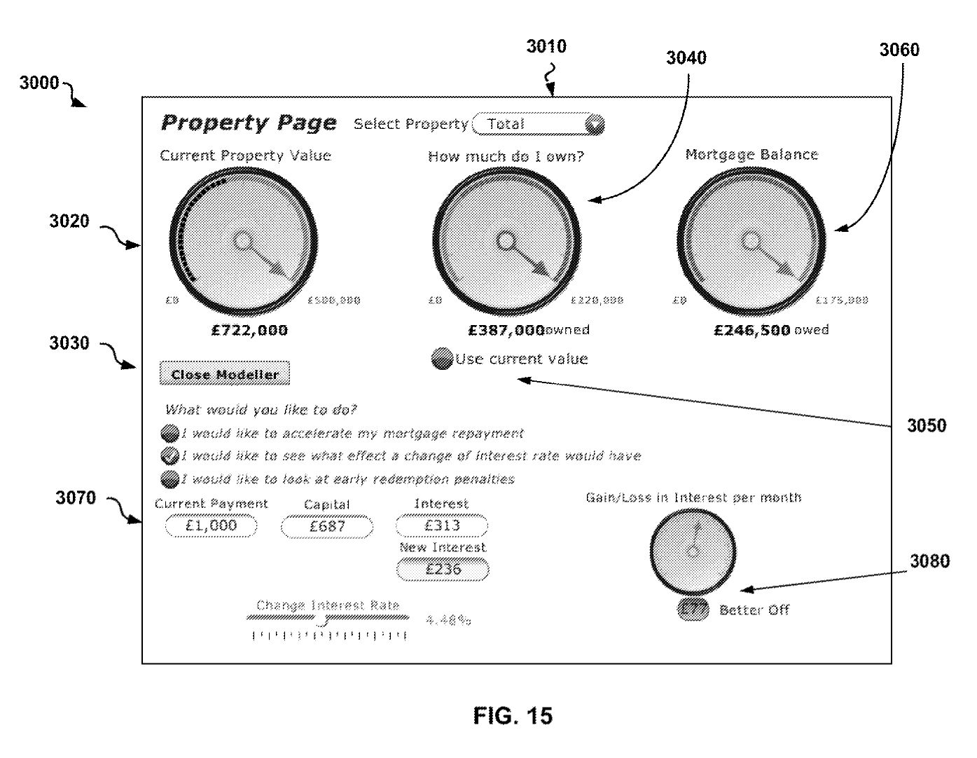

FIG. 14 and FIG. 15 illustrate one embodiment of a graphical user interface 3000 that displays the value of a user's real property using a dashboard-style presentation. The interface provides a pull-down menu 3010 to select one or all of the user's properties. The leftmost dial 3020 displays the total value of the user's property. The center dial 3040 shows the total debt and equity the user has in the property. If the user selects the “use current value” button 3050, the dial 3040 reflects the current market value of the property, otherwise it reflects purchase price. The rightmost dial 3060 displays mortgage balances. FIG. 13 illustrates one embodiment of a default display for the properties page 3000 wherein the total value and total mortgages on the user's properties are displayed.

The interface shown in FIG. 14 to 15 includes a modeling function for modeling the effect of changes in mortgage interest or payments. The function is activated by selecting a “Model” button 3030. FIG. 15 illustrates one embodiment of a modeling function displayed when the “Model” button 3030 is selected. The interface displays additional interface elements that allow an end user to model the effect of accelerating interest rate payments, model the effect of changes in interest, or view early redemption penalties. If, as in the illustrated example, the user selects changes in interest payments, the interface provides a slider bar to select an interest rate. The interface shows the change in interest. A savings dial 3080 shows the total gain or loss.

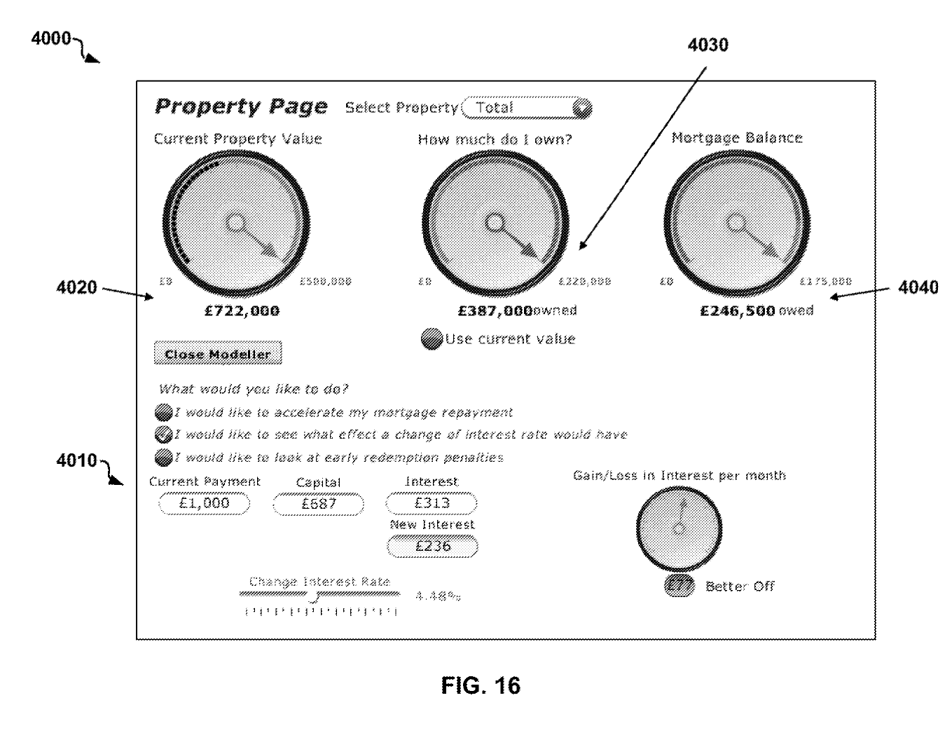

FIG. 16 illustrates one embodiment of a graphical user interface 4000 that displays the value of a user's assets using a dashboard-style presentation. The interface provides a dropdown menu 4010 that allows the user to select a category of assets to review for growth. In the illustrated example, stocks have been selected. The interface shows dials that graphically present the user's total asset value 4020, the value of the same assets 3 months ago 4030 and the value of the assets last year 4040.

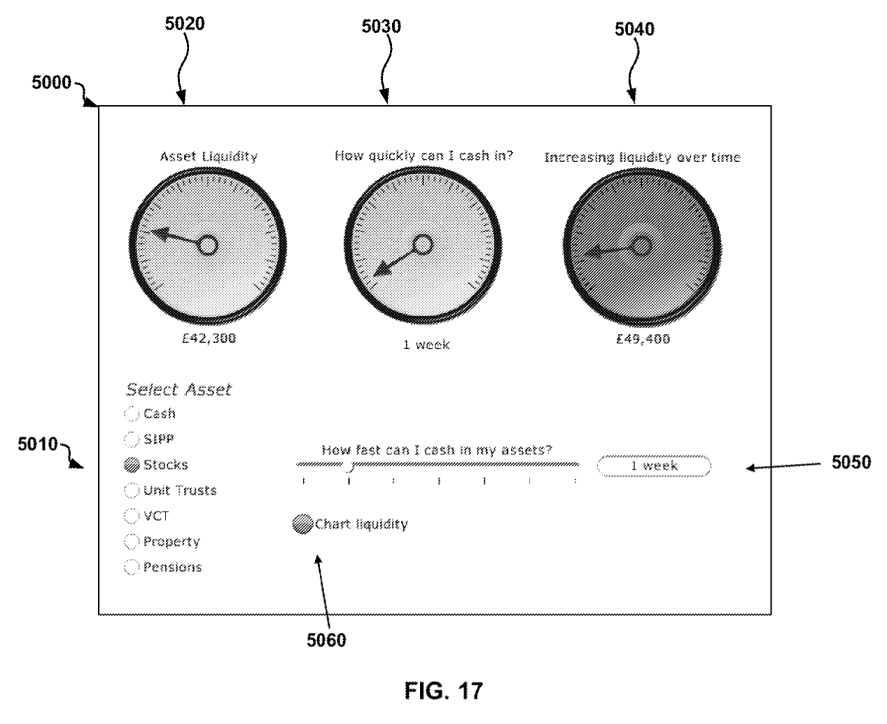

FIG. 17 illustrates one embodiment of a graphical user interface 5000 that displays the liquidity of a user's assets using a dashboard-style presentation. The interface provides a radio button interface 5010 that allows a user to select a category of assets. In the illustrated embodiment, stocks have been selected. Three dials display the value of liquid assets 5020, the amount of the assets that can be liquidated in a selected period 5030 and how liquidity will be increasing over time 5040. The interface provides a slider bar 5050 that can be used to select a period over which the user wishes to liquidate assets.

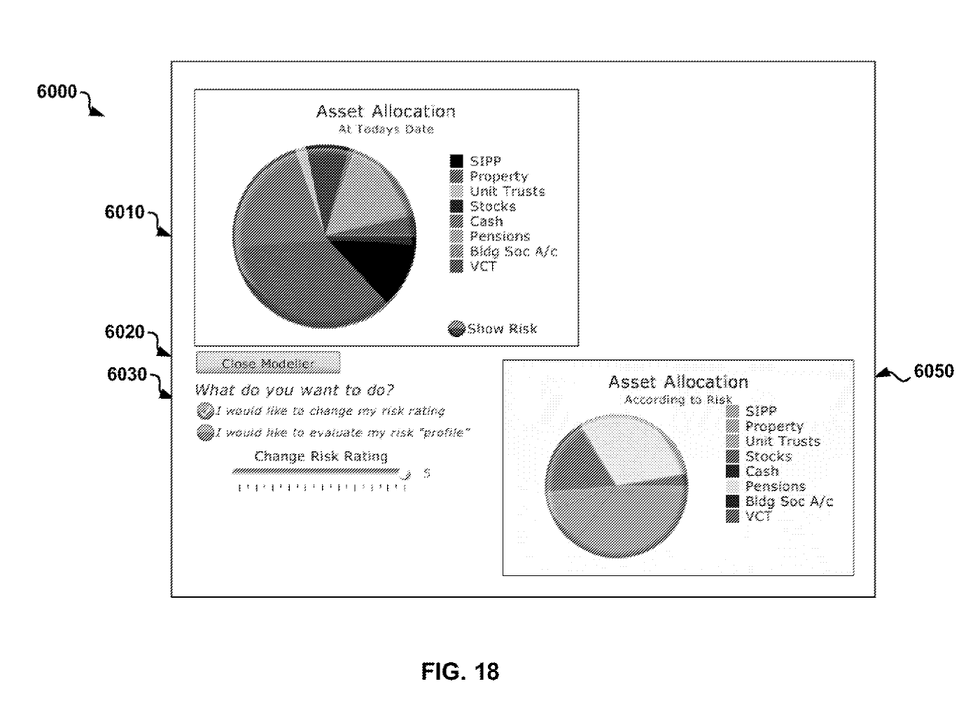

FIG. 18 illustrates one embodiment of a graphical user interface 6000 that displays the allocation of a user's assets. The interface displays the user's assets as a pie chart 6010. The interface provides a modeling function activated by a “Model” button 6020. The model function allows the user to change the users risk profile 6030. The interface provides a slider bar 6040 to adjust the user's risk rating. In the illustrated area, the user's risk profile has been changed to aggressive. A pie chart 6050 is displayed to show how a change in the user's risk profile causes suggested asset allocation to change.

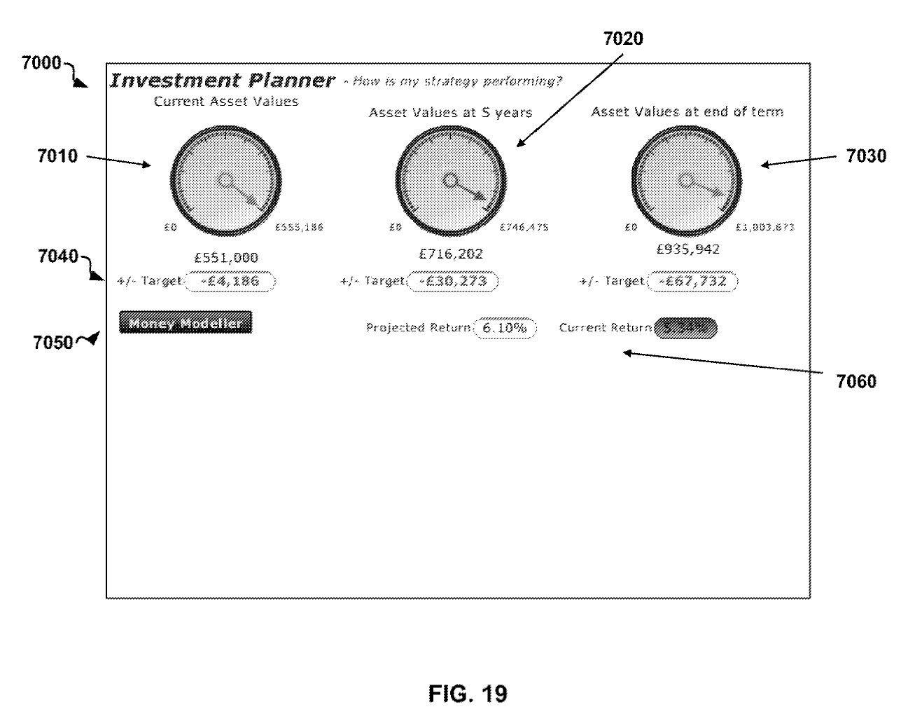

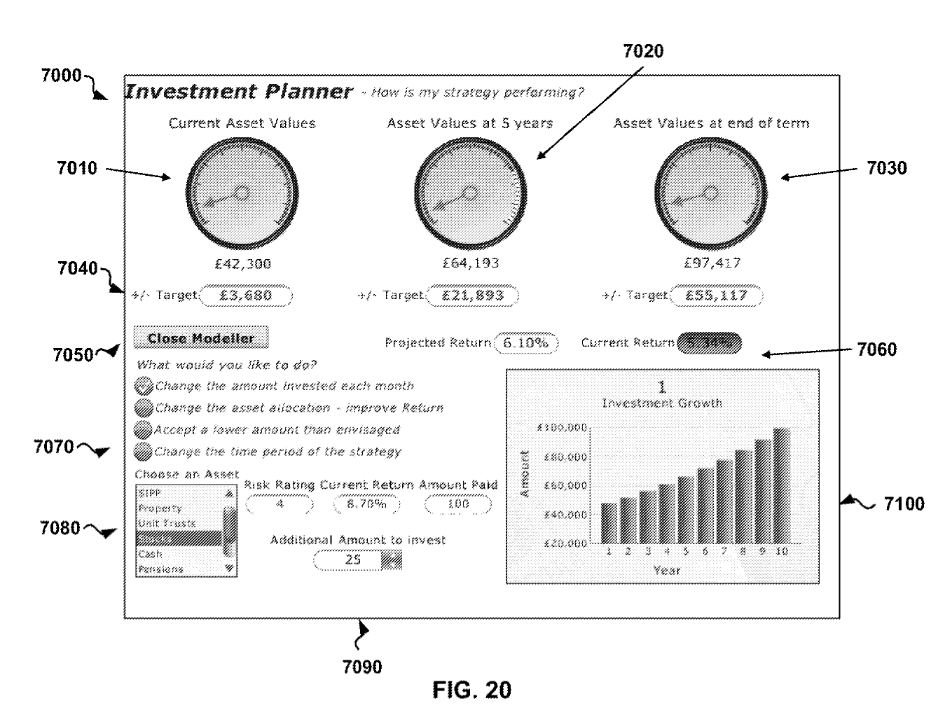

FIGS. 19 and 20 illustrates one embodiment of a graphical user interface 7000 that allows a user to evaluate and plan the user's long-term financial strategy using a dashboard-style presentation. The interface displays the total current value 7010 of the user's assets, the projected value of the user's assets at five years 7020, and the projected value of the users assets at the end of a term 7030 (e.g. retirement age.) In the illustrated example, the dials 7010-7030 show that current and projected asset values fall short of targeted values. The interface further displays current and projected variance of asset values from targeted values as numbers 7040. The interface further displays the current targeted (projected) return and actual return on investment 7060.

The interface shown in FIG. 19 and 20 includes a modeling function for modeling long-term financial choices. The function is activated by selecting a “Model” button 7050. FIG. 20 illustrates one embodiment of a modeling function displayed when the “Model” button 7050 is selected. The interface provides a set of buttons 8070 that allow the user to select a type of strategy to evaluate. In the illustrated embodiment the user has chosen to evaluate the effect of changes in investment amounts. The interface provides a dropdown menu 7080 that allows the user to select a type of investment. In the illustrated embodiment the user has chosen stocks. The interface further provides selection fields 7090 that allows the user to vary the risk rating, the current return, and investment amount for the selected asset. The interface displays the investment growth as a bar chart 7100.

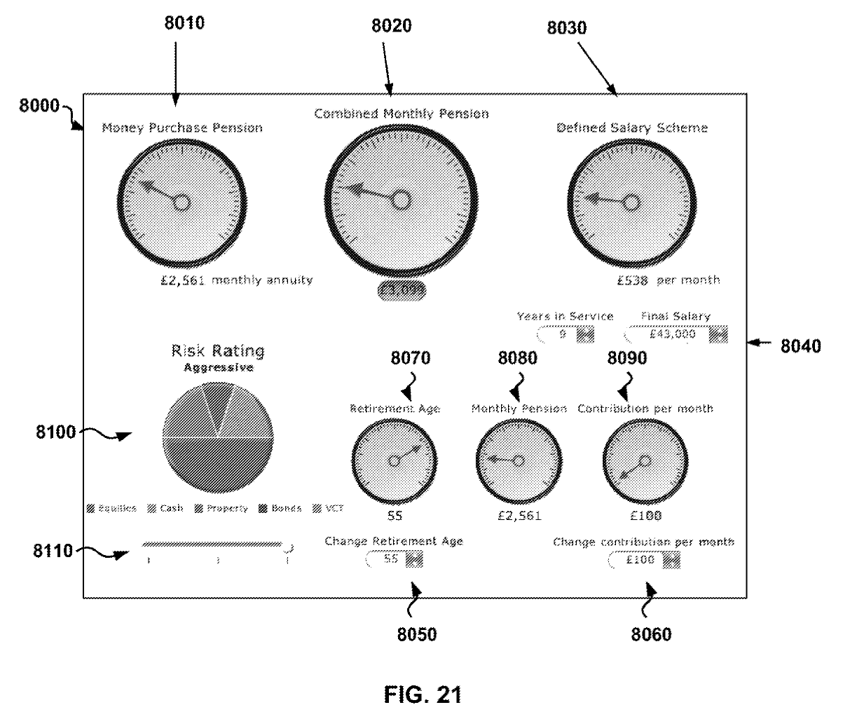

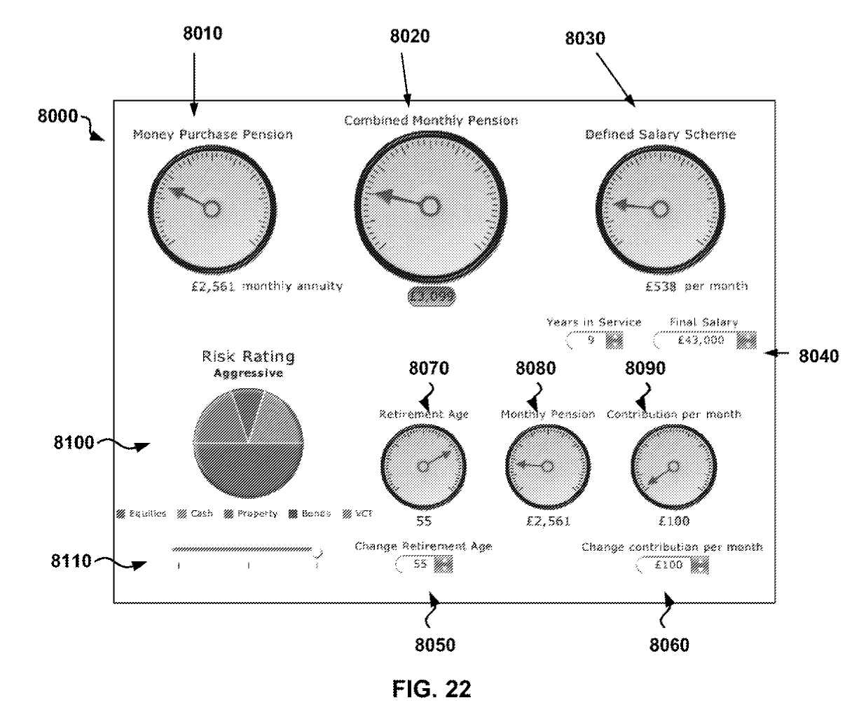

FIGS. 21 and 22 illustrates one embodiment of a graphical user interface 9000 that allows a user to evaluate and plan pension and retirement investments using a dashboard-style presentation. The interface displays the total pension amount a user expects to receive 8020 based on pension investments 8010 and defined pension benefits 8030. The amounts are calculated base on number of years of employment remaining 8040, retirement age 8070, and monthly contributions 8090. The interface further displays the user's projected asset allocation at retirement 8100.

The interface allows the user to model changes in financial choices at retirement by changing years in service and final salary 8040, retirement age 8050, monthly contribution 8060, and the aggressiveness of the user's financial choices 8110. FIG. 22 illustrates how by selecting more aggressive financial choices 8110, the user may be able to retire at a younger age 8050, yet achieve a higher retirement income 8020 due to a higher yield from pension investments 8010.

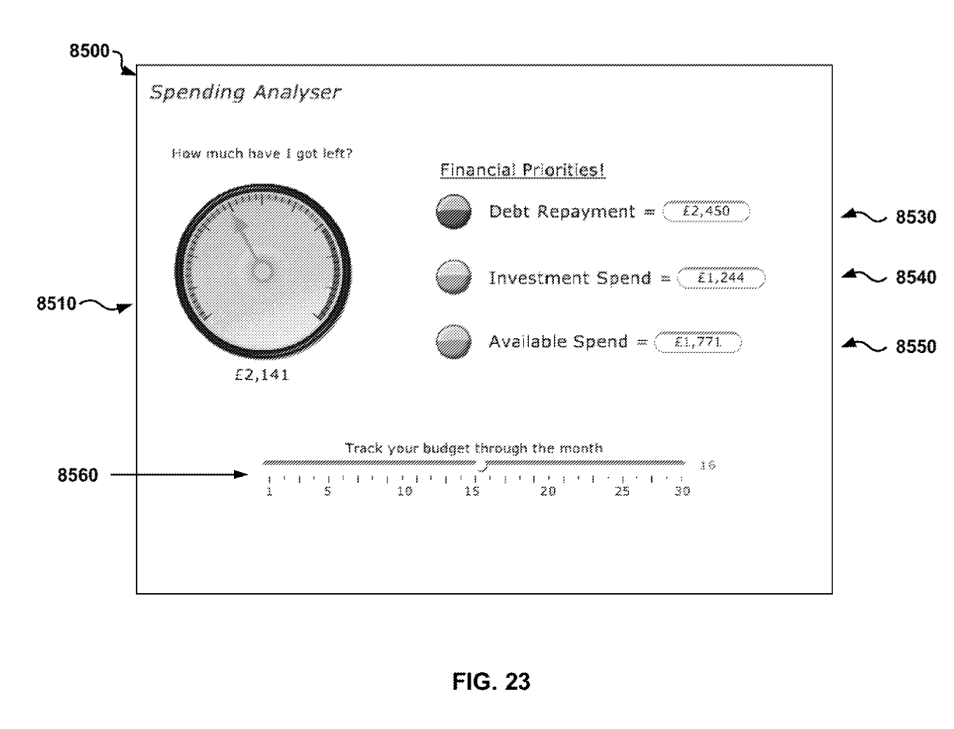

FIG. 23 illustrates one embodiment of a graphical user interface 8500 that allows a user to display and model spending patterns throughout a month. The user may select a day of the month to display the user's spending to date using a slider control 8560. The interface displays available funds 8510. The user may vary his spending priorities and increase or decrease amounts allocated to debt repayment 8530, investments 8540, and available funds 8550.

FIG. 24 to 26 illustrates one embodiment of a graphical user interface 9000 that allows a user to see the forecasted effects of the user's current financial plans over time using a dashboard-style interface. The interface displays a graph 9010 of the user's projected net worth over thirteen years. The graph includes flags displaying financial events, such as in the example, “Car Loan Finished.” A slider may be positioned on a date. The user's total net worth on that date is displayed on a total net worth dial 9030 which has elements which further display cash and cash in the bank. Two smaller dials 9040 are provided that display the user's total assets and total debts on the date selected by the slider.

The interface 9000 provides a text list box 9050 which displays system notices and alerts and a question entry box 9060 that allows the user to enter questions which may receive a response through an automated help database or a from live support person. The interface further provides elements to allow the user to add new financial product vehicles 9070 and 9080 and to build scenarios to compare various financial options. A wizard toolbar 9100 is provided to allow the user to perform various tasks such as budgeting, planning, profile updating, and so forth.

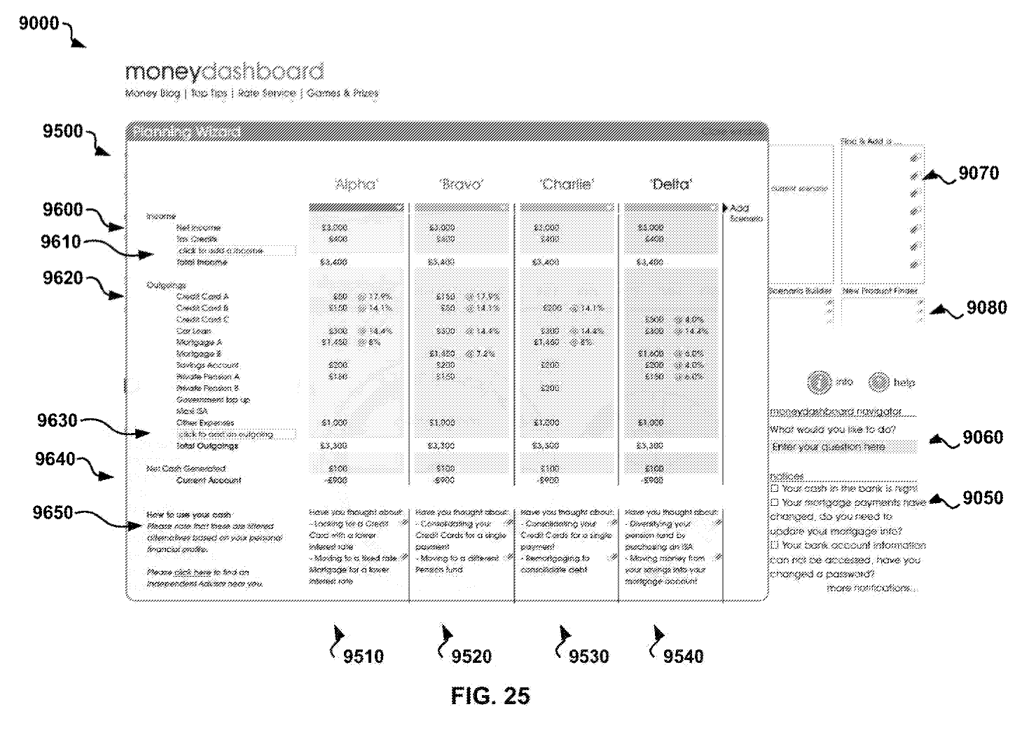

FIG. 25 illustrates a planning wizard pop-up window 9500 displayed when a user selects the planning wizard on the wizard toolbar 9100 (not visible in FIG. 25.) The window displays four possible scenarios 9510, 9520, 9530, and 9540 for the distribution of income and financial services. Each scenario displays income 9600, cash outflows 9620, and net cash generated and cash reserves 9640. The user may modify individual line items, such as changing an amount or interest paid on a line item. The user may or enter new income line items or cash outflow line items in using text entry boxes 9610 and 9630 respectively. As items are added and modified, the user can view the effect on cash flow produced by the scenario. The user may elect to display any number of the scenarios on the dashboard 9500.

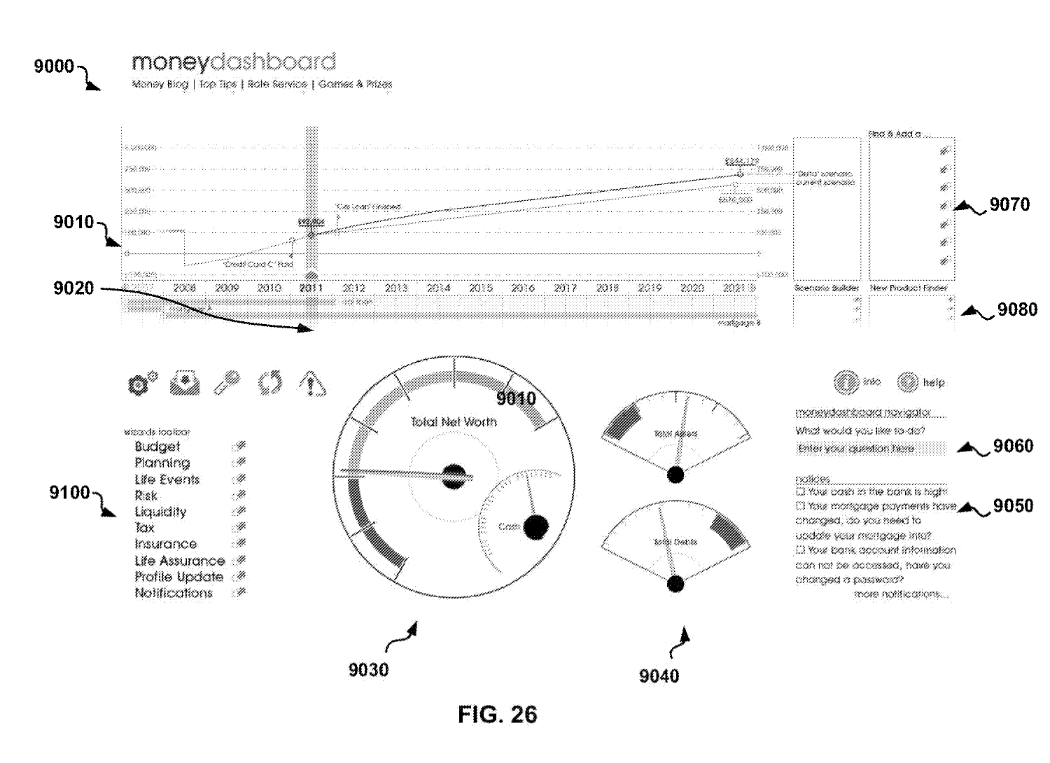

FIG. 26 illustrates one embodiment graphical user interface of FIG. 25 after a user has created a “Delta” scenario. The graph 9010 now displays a forecast of two scenarios, the user's current plans (in red) and the “Delta” scenario (in blue.) that allows a user to see the forecasted effects of his chosen new plan over time at a point in the future compared to his original plan. In the illustrated example, the “Delta” scenario outperforms the current scenario. The slider 9020 has been positioned to 2011 and the dials 9030 and 9040 display a projection of the users total net worth, assets and debts under the current scenario.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

I claim:

1. A method comprising the steps of:
receiving data over a network relating to a user's personal financial position from at least one system, wherein the at least one system includes an end user system;
storing the data relating to the user's personal financial position on a computer readable medium;
aggregating the data relating to the user's personal financial position;
forecasting anticipated changes in the user's personal financial position using the aggregated data relating to the user's personal financial position and stochastic forecasting techniques; and
displaying the aggregated data relating to the user's personal financial position in the form of total net worth and the forecasts of the anticipated changes in the user's personal financial position on a display device connected to the end user system;
wherein the aggregating storing, and forecasting steps are performed by at least one computer.

2. The method of claim 1 wherein the aggregated data relating to the user's personal financial position in the form of total net worth and the forecasts of the anticipated changes in the user's personal financial position are displayed on the display device using a graphical interface in the form of a dashboard.

3. The method of claim 1 additionally comprising the steps of:
receiving data over a network relating to the user's financial goals from the at least one system;
selecting at least one financial option that will help to achieve the user's financial goals;
displaying the at least one financial option on the display device connected to the end user system; and
receiving a selection over the network of at least one financial option;
wherein the selecting step is performed by at the at least one computer.

4. The method of claim 3 wherein displaying the at least one financial option includes a comparison of projected future financial scenarios to help identify the most effective future total net worth scenario for the user over a period of time

5. Method of claim 3 additionally comprising the step of:
alerting the user to significant divergence in their current financial position from their previous stochastic forecast, based on variations in total net worth, or specific financial vehicle worth, using tolerance variances set by the user.

6. The method of claim 3 additionally comprising the step of:
receiving additional data over the network relating to the user from the at least one system, wherein the additional data comprises at least one element selected from the group: profile data, behavioral data, contextual data and market condition data, wherein the additional data is used to select the at least one financial option.

7. The method of claim 3 additionally comprising the step of:
receiving additional data over the network relating to the user from the at least one system, wherein the additional data comprises at least one element selected from the group: profile, behavioral, contextual and market conditions,
using the additional data to select, using the at least one computer, at least one advertisement; and
displaying the at least one advertisement on the display device.

8. The method of claim 6 wherein the profile data contains at least one item selected from the group: risk aversion, ethical preferences, ability to afford and sustain financial products, cash flow analysis, tax efficiency, liquidity requirements.

9. The method of claim 7 wherein the profile data contains at least one item selected from the group: risk aversion, ethical preferences, ability to afford and sustain financial products, cash flow analysis, tax efficiency, liquidity requirements.

10. The method of claim 3 additionally comprising the step of:
sending a transaction to a financial product provider over a second network to purchase the selected financial options on behalf of the user.

11. The method of claim 1 wherein the data relating to the user's personal financial position is accumulated over a period of time, additionally comprising the step of
displaying the performance of the users financial choices over the period of time on the display device.

12. A computer-readable medium having computer-executable instructions for a method comprising the steps of:
receiving data over a network relating to a user's personal financial position from at least one system, wherein the at least one system includes an end user system over a network;
storing the data relating to the user's personal financial position on a computer readable medium;
aggregating the data relating to the user's personal financial position;
forecasting anticipated changes in the user's personal financial position using the aggregated data relating to the user's personal financial position and stochastic forecasting techniques; and
displaying the aggregated data relating to the user's personal financial position in the form of total net worth and the forecasts of the anticipated changes in the user's personal financial position on a display device connected to the end user system;
wherein the aggregating, storing, and forecasting steps are performed by at least one computer.

13. The computer-readable medium of claim 12 wherein the aggregated data relating to the user's personal financial position in the form of total net worth and the forecasts of the anticipated changes in the user's personal financial position are displayed on the display device using a graphical interface in the form of a dashboard.

14. The computer-readable medium of claim 12 additionally comprising the steps of:
receiving data over a network relating to the user's financial goals from the at least one system;
selecting at least one financial option that will help to achieve the user's financial goals;
displaying the at least one financial option on the display device connected to the end user system; and
receiving a selection over the network of at least one financial option;
wherein the selecting step is performed by at the at least one computer.

15. The computer-readable medium of claim 14 wherein displaying the at least one financial option includes a comparison of projected future financial scenarios to help identify the most effective future total net worth scenario for the user over a period of time

16. The computer-readable medium of claim 14 additionally comprising the step of:
alerting the user to significant divergence in their current financial position from their previous stochastic forecast, based on variations in total net worth, or specific financial vehicle worth, using tolerance variances set by the user.

17. The computer-readable medium of claim 14 additionally comprising the step of:
receiving additional data over the network relating to the user from the at least one system, wherein the additional data comprises at least one element selected from the group: profile data, behavioral data, contextual data and market condition data, wherein the additional data is used to select the at least one financial option.

18. The computer-readable medium of claim 14 additionally comprising the step of:
receiving additional data over the network relating to the user from the at least one system, wherein the additional data comprises at least one element selected from the group: profile, behavioral, contextual and market conditions,
using the additional data to select, using the at least one computer, at least one advertisement; and
displaying the at least one advertisement on the display device.

19. The computer-readable medium of claim 17 wherein the profile data contains at least one item selected from the group: risk aversion, ethical preferences, ability to afford and sustain financial products, cash flow analysis, tax efficiency, liquidity requirements.

20. The computer-readable medium of claim 18 wherein the profile data contains at least one item selected from the group: risk aversion, ethical preferences, ability to afford and sustain financial products, cash flow analysis, tax efficiency, liquidity requirements.

21. The computer-readable medium of claim 14 additionally comprising the step of:
sending a transaction to a financial product provider over a second network to purchase the selected at least one of the plurality of financial options on behalf of the user.

22. The computer-readable medium of claim 12 wherein the data relating to the user's personal financial position is accumulated over a period of time, additionally comprising the step of
displaying the performance of the users financial choices over the period of time on the display device.

23. A system comprising:
a data receiving module configured for receiving data relating to a user's personal financial position from at least one system over a network, wherein the at least one system includes an end user system;
a data storing module configured for storing the data relating to the user's personal financial position on a computer readable medium;
a data aggregating module configured for aggregating the data relating to the user's personal financial position;
a forecasting module configured for forecasting anticipated changes in the user's personal financial position using the aggregated data relating to the user's personal financial position using stochastic forecasting techniques; and
a data display module configured for displaying the aggregated data relating to the user's personal financial position in the form of total net worth and the forecasts of the anticipated changes in the user's personal financial position on a display device connected to the end user system.

24. The system of claim 23 wherein data display module is configured for displaying the aggregated data relating to the user's personal financial position in the form of total net worth and the forecasts of the anticipated changes in the user's personal financial position using a graphical interface in the form of a dashboard.

25. The system of claim 23 additionally comprising a financial choice selection module wherein
the data receiving module is additionally configured for receiving a user's financial goals from the at least one system over the network,
the financial choice selection module is configured for selecting at least one financial option that will help to achieve the user's financial goals;
the data display module is additionally configured for displaying the at least one financial option on the display device connected to the end user system, and
the data receiving module is additionally configured for receiving a selection of the at least one financial option from the at least one system over the network.

26. The system of claim 23 wherein the data display module is additionally configured for displaying the at least one financial option including a comparison of projected future financial scenarios to help identify the most effective future total net worth scenario for the user over a period of time

27. System of claim 23 additionally comprising:
a data alerting module that is configured for alerting the user to significant divergence in their current financial position from their previous stochastic forecast, based on variations in total net worth, or specific financial vehicle worth, using tolerance variances set by the user.

28. The system of claim 25 wherein
the data receiving module is additionally configured for receiving additional data over the network relating to the user from the at least one system, wherein the additional data comprises at least one element selected from the group: profile data, behavioral data, contextual data and market condition data, and
wherein the financial choice selection module is configured for using the additional data to select the at least one financial option.

29. The system of claim 25 additionally comprising an advertisement selection module, wherein
the data receiving module is additionally configured for receiving additional data over the network relating to the user from the at least one system, wherein the additional data comprises at least one element selected from the group: profile, behavioral, contextual and market conditions,
the advertisement selection module is configured for using the additional data to select at least one advertisement, and
the data display module is additionally configured for displaying the at least one advertisement on the display device.

30. The system of claim 28 wherein the profile data contains at least one item selected from the group: risk aversion, ethical preferences, ability to afford and sustain financial products, cash flow analysis, tax efficiency, liquidity requirements.

31. The system of claim 29 wherein the profile data contains at least one item selected from the group: risk aversion, ethical preferences, ability to afford and sustain financial products, cash flow analysis, tax efficiency, liquidity requirements.

32. The system of claim 25 additionally comprising:
a financial product purchase module configured for sending a transaction to a financial product provider over a second network to purchase the selected at least one of the plurality of financial options on behalf of the user.

33. The system of claim 23 wherein the a data storing module is additionally configured for accumulating the data relating to the user's personal financial position over a period of time, and wherein
the data display module is additionally configured for displaying the performance of the users financial choices over the period of time on the display device.
